(19) United States
(12) Patent Application Publication
(10) Pub. No.: US 2017/0312736 A1
(43) Pub. Date: Nov. 2, 2017

(54) USE OF A COMPOSITE TEXTILE OF NATURAL AND/OR SYNTHETIC AND/OR ARTIFICIAL FIBRES AND LIGNOCELLULOSE PARTICLES FOR TRAPPING THE METALS AND/OR METALLOIDS AND/OR RADIONUCLIDES AND/OR BIOCIDES PRESENT IN WATER

(71) Applicant: PE@RL, Limoges (FR)

(72) Inventors: Löic Jauberty, Limoges (FR); Philippe Devos, Limoges (FR)

(73) Assignee: PE@RL, Limoges (FR)

(21) Appl. No.: 15/520,566

(22) PCT Filed: Oct. 20, 2015
(86) PCT No.: PCT/EP2015/074274

§ 371 Date: Apr. 20, 2017

(30) Foreign Application Priority Data
Oct. 20, 2014 (FR) 1460092

(51) Int. Cl. B01J 20/28; B01J 20/24; D04H 1/425; B01J 20/26; B01J 20/30; B01J 20/32; C02F 1/28; D04H 1/48; C02F 101/00; C02F 101/20; C02F 103/00; C02F 103/10; C02F 103/16

(52) U.S. Cl. CPC B01J 20/28028; D04H 1/48; B01J 20/24; D04H 1/425; B01J 20/26; B01J 20/28004; B01J 20/3028; B01J 20/3206; C02F 1/288; C02F 1/286; B01J 20/3295; C02F 2101/006; C02F 2101/20; C02F 2103/001; C02F 2103/10; C02F 2103/16

(57) ABSTRACT

The invention relates to the use of a composite textile of natural and/or synthetic and/or artificial fibres and lignocellulose particles mixed with said fibres comprising more than 30 wt. % of said lignocellulose particles in order to trap the metals and/or metalloids and/or radionuclides and/or biocides present in water.

The invention relates to the use of a composite textile comprising several textile layers impregnated with lignocellulosic particles capable of absorbing metals (copper, gold, iron, etc.) and/or metalloids and/or radionuclides such as uranium and/or biocides.

The invention falls within the field of water treatment, in particular water treatment in order to remove metals and/or metalloids and/or radionuclides and/or biocides therefrom.

The person skilled in the art still has too few solutions in this field, particularly “green” solutions, i.e., those which limit environmental impacts.

This treatment is provided today by ion-exchange resins, chemical precipitations, or activated carbon. Even if these methods have an efficient trapping rate, they also have the following disadvantages: high cost, substantial maintenance and maintenance, and sludge production.

Furthermore, these devices in no way make it possible to decrease the quantity of waste or the recycling of trapped metals.

For example, in the field of the treatment of water loaded with radioelements, the volume of waste (chemical discharge and radioactive sludge) is particularly crucial.

For example, in the field of mining of metals and particularly of precious metals, the recovery of trace amounts of metal in the water can be particularly lucrative.

The aim of the invention consists in providing a material, preferably natural, renewable, recyclable, biodegradable and incinerable, for trapping metals and/or metalloids and/or radionuclides and/or biocides in the water of the locations from which they are extracted as well as in the locations in which they are used.

It is known that plants have a particular propensity to absorb metals and radionuclides. WO2011042671 is an international application of the Applicant which describes a method for treating bark to improve its radionuclide trapping properties.

Surprisingly, the inventors discovered that the incorporation of pine bark granules of a suitable size and in a sufficient quantity in a natural nonwoven material consisting of fibres of flax and of PLA-corn makes it possible to considerably improve the trapping of metals contained in the water by said bark.

The adsorption of the textile of the invention is particularly advantageous compared to the granules alone, even compared to the granules bagged in a natural fibre textile.

### SUMMARY OF THE INVENTION

The invention relates to the use in a composite textile of natural and/or synthetic and/or artificial fibres and lignocellulosic particles entangled in said fibres comprising more than 30% by weight of said lignocellulosic particles for treating water with the aim of trapping metals and/or metalloids and/or radionuclides and/or biocides contained therein.

The invention also relates to the use in a woven or nonwoven textile of lignocellulosic particles in a quantity of 30 to 80% by weight of said textile for trapping metals and/or metalloids and/or radionuclides and/or biocides.

### Definitions

By “lignocellulosic” is meant any material derived from a woody plant composed of lignin, hemicellulose and cellulose in variable proportions such as bark, for example pine bark, chestnut bark, for example sawmill waste, for example sawdust, for example agricultural waste, for example coconut fibre.

By “entangled” is meant mixed together in a disordered manner, i.e., arranged randomly within the fibres according to the present invention, and wherein cohesion is provided only by the manner in which the particles are arranged (no chemical treatment).

Within the meaning of the present invention, by “particle” is meant a piece, irrespective of its shape, that is an additional constituent of the textile and that is not part of the weft of the textile. The textile consists of fibres to which the particles of the present invention are added.

By “natural fibre” is meant a plant or animal fibre capable of being used in the textile industry because of its natural “textile” properties without undergoing a physicochemical treatment which profoundly modifies its characteristics (length, suppleness, etc.).

By “synthetic fibre” is meant any synthetic fibre, for example by decomposition, polymerization, extrusion, etc., manufactured from artificial polymers, for example of polyester, polyamide or polypropylene type.

By “artificial fibre” is meant a synthetic fibre of plant or animal origin manufactured by man by modification of a natural raw material such as PLA fibres, cellulose, fibres based on crustacean shell chitin.

By “mineral fibre” is meant a natural fibre derived directly from rock, such as for example asbestos, wollastonite or sepiolite, or an artificial fibre such as glass fibre, glass wool, rock wool, ceramic fibre or alumina fibre.

By “biodegradable” is meant decomposable into various elements free of detrimental effects on the natural environment under the action of living organisms external to its sub stance.

By “textile” is meant a woven or nonwoven textile.

A “nonwoven textile” or “nonwoven” is a manufactured product consisting of a web, a sheet or a batt of fibres which are distributed directionally or by chance, and whose internal cohesion is provided by mechanical and/or physical and/or chemical methods and/or by a combination of these various methods, excluding weaving and knitting. According to the ISO 9092 definition, nonwovens are fibres oriented randomly or directionally transformed into a web or batt, consolidated and bonded by friction, and/or cohesion and/or adhesion.

By “animal fibres” is meant any natural or artificial animal fibre of animal origin.

Among natural animal fibres, mention may be made of animal hair such as sheep's wool, alpaca wool, angora wool, cashmere, camel wool, animal hair, mohair wool, yak wool, or silk.

Among artificial fibres of animal origin, mention may be made of fibres based on crustacean shell.

By “plant fibres” is meant any natural or artificial plant fibre of plant origin.

Among natural plant fibres, mention may be made of fibres of hemp, of cotton, in particular of organic cotton, of flax, jute, kapok, kenaf, ramie fibres, sisal.

Among artificial fibres of plant origin, mention may be made of any fibre obtained from a cellulose material such as bamboo viscose, PLA fibre, soy viscose, fibres based on wood pulp, fibres based on dried algae.

By particle “size” is meant the largest measurement of the three dimensions of the particle, for example the diameter for a spherical particle, the length for a needle or a parallelepiped.

By “metalloid” is meant a chemical element that can be classified neither as a metal nor a non-metal, having intermediate properties between metal and non-metal. The metalloid according to the invention may be boron, silicon, germanium, arsenic, antimony, tellurium or astatine, and is preferably arsenic.

### FIGURES

FIG. 1: Monitoring of copper concentrations as a function of the volume of solution passed through each product:

[symbol] Lignocellulosic particles alone

[symbol] Bagged lignocellulosic particles

[symbol] Fibres alone

[symbol] Nonwoven material according to the invention

Y-axis: Copper concentration at the column outlet (mg/L)

X-axis: Volume of solution passed through the column (L)

FIG. 2: Percentage of copper not retained at the column outlet as a function of the volume of solution passed through each product:

[symbol] Lignocellulosic particles alone

[symbol] Bagged lignocellulosic particles

[symbol] Fibres alone

[symbol] Nonwoven material according to The invention

Y-axis: Percentage of copper not retained at the column outlet

X-axis: Bed volume passed

FIG. 3: Percentage of copper retained at the column outlet as a function of the volume of solution passed through each product:

[symbol] Lignocellulosic particles alone

[symbol] Bagged lignocellulosic particles

[symbol] Fibres alone

[symbol] Nonwoven material according to the invention

Y-axis: Percentage of copper retained at the column outlet

X-axis: Bed volume passed

FIG. 4: Average percentage of copper not retained at the column outlet as a function of the volume of solution passed through each product:

[symbol] Lignocellulosic particles alone

[symbol] Bagged lignocellulosic particles

[symbol] Fibres alone

[symbol] Nonwoven material according to the invention

Y-axis: Average percentage of copper not retained

X-axis: Bed volume passed

FIG. 5: Average percentage of copper retained at the column outlet as a function of the volume of solution passed through each product:

[symbol] Lignocellulosic particles alone

[symbol] Bagged lignocellulosic particles

[symbol] Fibres alone

[symbol] Nonwoven material according to the invention

Y-axis: Average percentage of copper retained

X-axis: Bed volume passed

### DETAILED DESCRIPTION

The present invention relates to the use of a textile for treating water with the aim of trapping metals and/or metalloids and/or radionuclides and/or biocides contained therein.

These metals and/or metalloids and/or radionuclides and/or biocides may be present in the water in any quantity, even trace quantities.

Metals include lead, nickel, chromium, zinc, copper, gold, silver, iron, mercury, cadmium.

Metalloids include boron, silicon, germanium, arsenic, antimony, tellurium and astatine, preferably arsenic.

Radionuclides include uranium, plutonium, palladium, americium, polonium, radium, caesium in their various isotopic forms.

Biocides include pesticides, antiparasitics and antibiotics.

Among pesticides, particular mention may be made of insecticides, fungicides, herbicides, parasiticides, antimicrobials, algicides, acaricides, antimicrobials, bactericides, crow toxicants, molluscicides, nematicides, ovicides, rodenticides, mole toxicants, virucides, repellent products, and biopesticides.

Among herbicides, particular mention may be made of selective weed killers, total weed killers, bush killers, top killers, sprout inhibitors, and silvicides.

The use according to the invention can take place in certain extraction mines or in certain metal or metalloid processing industries or in sites where radionuclides or biocides are used.

The use according to the invention relates to drinking water as well as to water arising from oceans, seas, rivers, lakes, ponds, reservoirs, streams and watercourses, ground seepage water at industrial pollution sites and leachates.

The use according to the invention consists in using the textile as a filter. For each application, the textile is placed in such a way that the water to be treated passes through it and the metals and/or metalloids and/or radionuclides and/or biocides contained therein are trapped.

By way of example, certain applications are as follows:
Fixation of radionuclides in nuclear plant decontamination tanks. Here, the textile is located in the decontamination tanks.
Fixation of copper before penetration of the soil in vineyards after copper treatment, for example with Bordeaux mixture. Here, the textile is deposited on or in the soil.
Fixation of metal, for example precious metal such as gold in ground seepage water of extraction mines.
Fixation of metal, particularly of iron in discharge purification leachates.
Recovery of agricultural phytosanitary products either from runoff after manuring or when the material is washed.

Another object of the invention relates to the use in a woven or nonwoven textile of lignocellulosic particles in a quantity of 30 to 80% by weight of said textile for trapping metals and/or metalloids and/or radionuclides and/or biocides.

The textile used in the present invention is a composite textile of natural and/or synthetic and/or artificial fibres and lignocellulosic particles entangled between said fibres comprising more than 30% by weight of said particles.

Advantageously, the textile is biodegradable.

Preferentially, the particles are entangled in said fibres only thanks to the mechanical steps of manufacture of said textile. No binder- or resin-type additive is used to create bonds between the particles and the fibres. The size of the particles is sufficiently small to offer a large contact surface for adsorption and thus to generate an optimal treatment capacity.

The size of the particles is sufficiently large to allow them to be held between the fibres.

The size of the particles is thus between 0.1 and 10 mm, preferably between 0.2 and 4 mm, in a particularly preferred manner between 0.4 and 3 mm. Advantageously, the size of the particles is less than 1 mm.

Advantageously, the textile comprises 30 to 80%, preferably 40 to 75% by weight of lignocellulosic particles in relation to the total weight of the textile, in a particularly preferred manner 50% to 70%.

Advantageously, the textile comprises 20 to 80%, preferably 20 to 60% by weight of fibres in relation to the total weight of the textile, in a particularly preferred manner 30 to 50%.

The thickness of the textile is between 3 and 20 mm, preferably between 8 and 15 mm.

The weight of the textile is between 0.1 and 2 kg/m², preferably between 0.8 and 1.5 kg/m².

Preferably, the textile is nonwoven.

According to an embodiment, the fibres of the textile according to the invention are natural and/or artificial fibres.

According to an embodiment, all the fibres of the textile consist of plant fibres.

Preferably, the fibres of the textile are exclusively flax fibres and PLA fibres. The material used for the manufacture of PLA fibres is corn starch. The latter is transformed into sugar which, by decomposition thanks to microorganisms, becomes the acid lactide. This acid is polymerized to become polylactide then extruded to manufacture PLA fibre.

According to another embodiment, the fibres of the textile are natural fibres, preferably natural plant fibres, and preferentially exclusively flax fibres.

According to an embodiment, the textile is functionalized, for example by manganese permanganate or manganese dioxide MnO₂.

According to another embodiment, the fibres of the textile are synthetic fibres.

Advantageously, the synthetic fibres may be selected from the group consisting of polyesters, polyamides, polypropylenes, and mixtures thereof.

According to another embodiment, the fibres of the textile are artificial fibres.

Advantageously, the artificial fibres may be of animal origin, of plant origin or of mineral origin.

Advantageously, the artificial fibres may be selected from the group consisting of viscoses such as soy viscose, PLA fibres, fibres based on cellulose, fibres based on crustacean shell chitin, fibres based on bamboo, fibres based on wood pulp, fibres based on dried algae, and mixtures thereof; preferably, the artificial fibres are selected from the group consisting of viscoses.

Advantageously, the synthetic and/or artificial fibres are biodegradable, partially biodegradable or non-biodegradable.

According to an embodiment, part of the natural and/or artificial fibres of the textile may be mineral fibres.

Advantageously, the mineral fibres may be natural mineral fibres such as asbestos, or artificial mineral fibres such as ceramic fibre, glass fibre, or metal fibres.

According to an embodiment, the textile comprises at least 50% by weight of natural fibres, in relation to the total weight of fibres in the textile according to the invention, preferably at least 70% by weight, more preferentially at least 80% by weight.

According to an embodiment, the textile comprises at least 50% by weight of synthetic fibres, in relation to the total weight of fibres in the textile according to the invention, preferably at least 70% by weight, more preferentially at least 80% by weight.

According to an embodiment, the textile comprises at least 50% by weight of artificial fibres, in relation to the total weight of fibres in the textile according to the invention, preferably at least 70% by weight, more preferentially at least 80% by weight.

According to an embodiment, the textile comprises at least 50% by weight of natural and/or artificial fibres, in relation to the total weight of fibres in the textile according to the invention, preferably at least 70% by weight, more preferentially at least 90% by weight.

According to an embodiment, the textile comprises at least 50% by weight of plant fibres, in relation to the total weight of fibres in the textile according to the invention, preferably at least 70% by weight, more preferentially at least 80% by weight.

The textile used for trapping metals and/or metalloids and/or radionuclides and/or biocides according to the invention may be prepared according to a process comprising the following steps.

According to the following first embodiment, this manufacturing process is suitable for the manufacture of a nonwoven material.

The fibres are first disentangled by the carding process.

The web thus obtained is then stacked by a napping operation then pressed then consolidated by needling and/or thermobonding.

The napping operation consists in stacking the webs of carded fibres to obtain the desired sheet thickness.

Thermobonding consists in passage in an oven after passage in a press. Thermobonding requires the presence of thermofusible fibres in the web. Thermobonding is a process for consolidating the sheet which calls upon the thermoplastic properties of certain fibres in the composition of the web. Under the effect of heat, the thermofusible fibres (the melting point of which is lower than that of the other fibres constituting the sheet) melt and thus bond all the fibres together.

Needling consists in entangling the textile fibres together and potentially into a fabric, by means of special needles bearing barbs or by means of hydraulic jets (hydraulic needling). Needling makes it possible to entangle the fibres constituting the nonwoven sheet by means of special needles or hydraulic jets which create vertical fibre bridges between the various webs in order to keep them together and thus ensure the performance of the finished product.

In the case of needling, the number of perforations generally made is in a range of 30 to 200 perforations per cm², and commonly around 150 perforations per cm².

The lignocellulosic particles are deposited between two layers of nonwoven carded fibre webs during napping.

In the presence of thermofusible fibres, the process of the invention will favour thermobonding rather than needling.

In the absence of thermofusible fibres, needling is used, optionally followed by a high-temperature passage. This high-temperature passage may last from a few minutes to about 30 minutes, preferably from 5 to 15 minutes. By “high temperature” is meant a temperature above 100° C.

According to the following second embodiment, the manufacturing process is suitable for the manufacture of a woven textile used according to the invention. The lignocellulosic particles are then either:
deposited in the card web which is then spun then woven or knitted
incorporated into the yarn at the time of spinning, then the yarn is woven or knitted
incorporated at the time of weaving or knitting.

According to a particular embodiment of the invention, the lignocellulosic particles are treated before being incorporated into the woven or nonwoven textile to optimize their capacity to trap metals and/or metalloids and/or radionuclides and/or biocides.

The steps of this embodiment are as follows.

The first particle treatment step is a step consisting of rinsing, washing, and removing residual fines after the grinding step and the various transfer and storage steps. Certain water-soluble compounds such as tannins or others phenolic compounds are partially released into the wash water, and simultaneously the bark absorbs water, causing swelling by hydration. The particles thus pre-prepared are then activated to give them ion-exchange functionalities. A solution for solubilization of tannins and phenolic compounds is employed, with the order of these two treatments being unimportant. The activation of the particles is obtained in a known manner by an acid treatment, in this case nitric acid at 0.1 M, i.e., at 0.1 mole per litre). The acid causes exchanges of the salts Na, K, Ca and P, to cite the primary compounds of the ion-exchange sites by H protons. The monitoring consists in measuring conductivity as a function of pH.

The treatment time is defined when the conductivity reaches a horizontal asymptote, generally when the solution reaches a maximum acidity, i.e., a pH on the order of 1, with the conductivity able to reach values of about 40 μs/cm. The particles are then rinsed again to remove the acid solution. Hence, the particles regain a pH close to 7 and therefore neutrality. Simultaneously, the conductivity returns to the conductivity of distilled water. During this phase, the water-soluble compounds are again removed. Nevertheless, water-soluble compounds remain, and the latter should no longer be released subsequently during the use of the finished product for purposes of treating fluids, notably water, with a view to recovering metals, notably heavy metals and/or metalloids and/or radionuclides and/or biocides. Thus, it is necessary to stabilize the particles thus activated and ready to be used to prevent any subsequent release of water-soluble compounds.

A solubilization solution consists in treating said particles by making them undergo an oxidation reaction known as Fenton oxidation. This oxidation reaction causes a decrease in the size of tannins or other phenolic compounds, thus making them easily soluble. These soluble compounds are then removed from the wash water, preventing their subsequent solubilization during the filtration phases with a view to retaining radionuclides and/or heavy metals and/or metalloids and/or biocides since these water-soluble compounds are absent. This solubilization treatment relies on the Fenton oxidation reaction. This reaction is illustrated below:

Fe²⁺+H₂O₂=Fe³⁺+OH⁻+.OH

Thus, it is noted that this reaction makes possible the opening of rings and a decrease in the size of molecules, thus enabling their solubilization in and removal from the wash water during preparation of the bark. Moreover, this reaction causes the opening of the benzene rings of lignins to form carboxyl groups and thus to increase the number of sites available for adsorption.

The following examples illustrate the invention without limiting its scope.

### Examples

### Example 1: Preparation of Bark Particles

Douglas pine bark is ground into granules having a size of less than 10 mm.

### Example 2: Manufacture of a Nonwoven Composite According to the Invention

Flax fibres are carded. The web thus obtained is then stacked by napping. Between each web layer, granules obtained according to Example 1 are deposited in a ratio of 50% flax fibres and 50% granules by weight.

The whole is then pressed then needled then passed in a 160° C. oven for 10 min.

### Example 3: Manufacture of a Nonwoven Composite According to the Invention

Fibres of flax and of PLA are carded. The web thus obtained is then stacked by napping. Between each web layer, granules obtained according to Example 1 are deposited in a ratio of 25% flax fibres, 25% PLA fibres and 50% granules by weight.

The whole is then pressed then consolidated by thermobonding.

The nonwoven composite obtained has a thickness of 5 mm and a weight of 600 g/m².

### Example 4: Characterisation of the Copper Adsorption Capacities of the Product of Example 3

### Aim

The aim is to characterise the capacities to adsorb trace metal elements (TMEs) of the material as a function of its packing. Three configurations are tested: loose bark, bagged bark and the composite nonwoven fabric according to the invention.

### Principle

In the 3 cases tested, 20 mL (bulk volume of the product), or about 3 g of product, is packed in a column. A solution, whose TME concentration to be tested is known, is percolated through this column and a measurement is taken regularly at the outlet to confirm the efficiency of the treatment.

### Test Protocol on Copper

The TME solution used here has an initial copper concentration of 3 mg/L. This element, in addition to being a potential pollutant to be treated, has the advantage of being easily assayable and is representative of a number of other divalent cationic pollutants. A measurement at the column outlet is carried out every 25 bed volumes (BV), i.e., every 500 mL in this case, the bed volume being equal to 20 mL.

The results are compared with those obtained for the adsorption of uranium, the concentration of which was 0.3 mg/L.

For reasons of homogeneity, all the results are presented as if they had been carried out at a concentration of 0.3 mg/L, i.e., the volumes passed with copper were multiplied by to compensate for the 10 times greater concentration in solution, which is equivalent to the same quantity of fixed element.

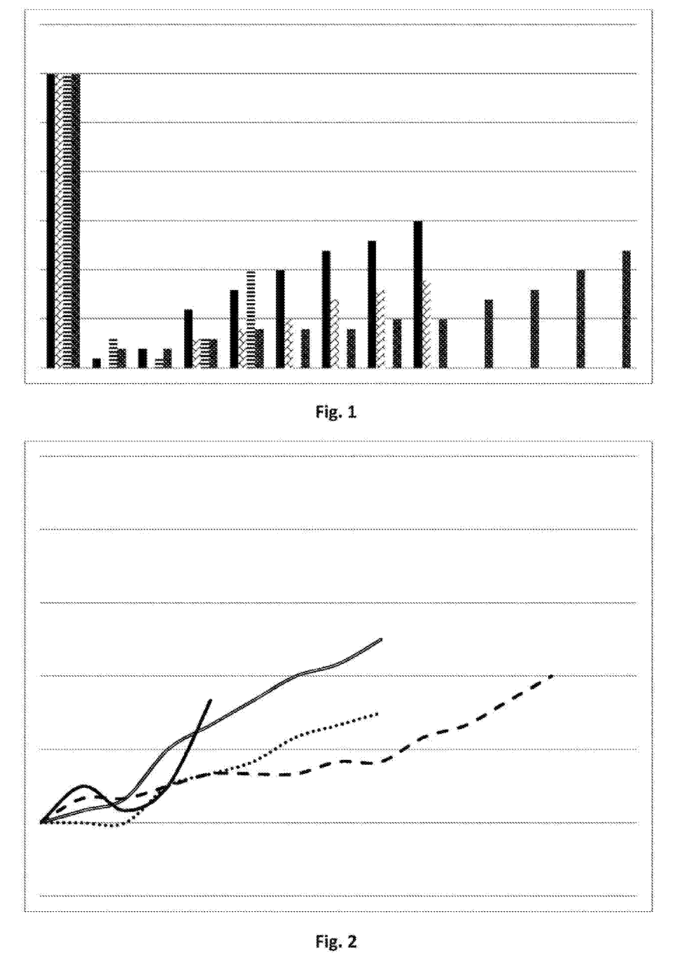

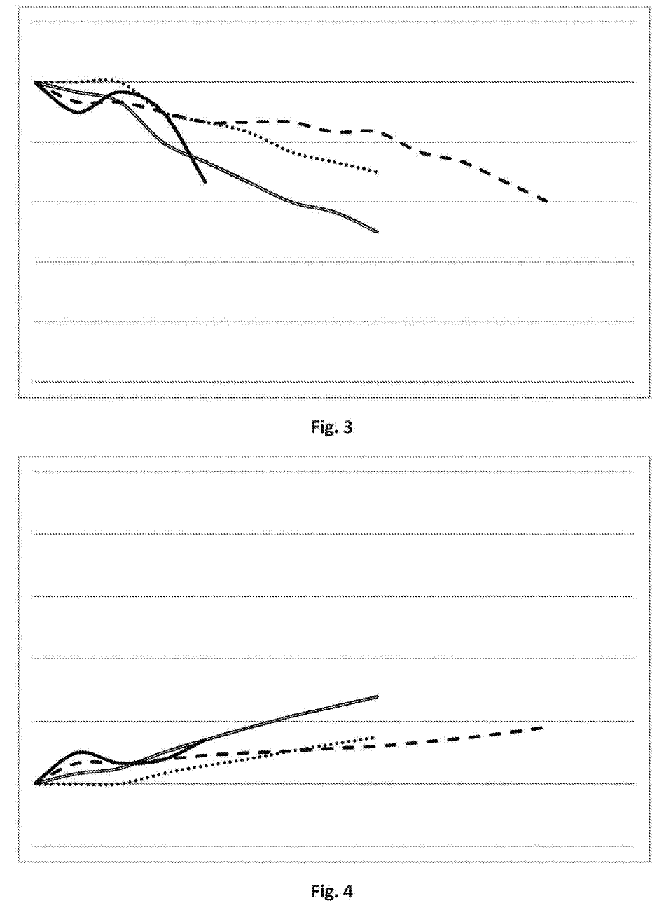

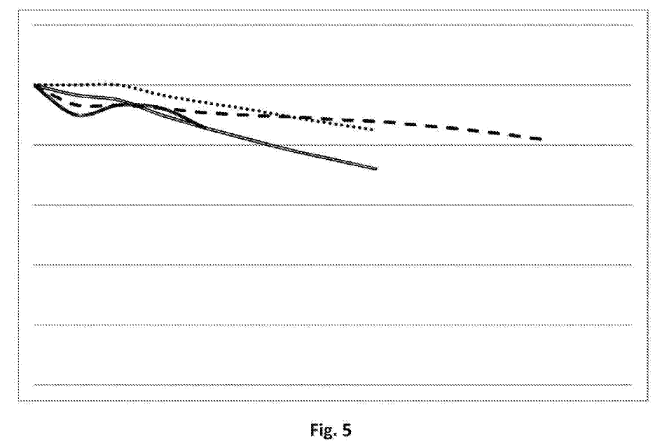

The fixation efficiency results are presented in FIGS. 1 to 5:

The loose configuration is represented by a double line, the bagged configuration by a dotted line, and the configuration according to the invention by a dashed line.

It is observed that if one refers to the fixation efficiency as the efficiency criterion, the configuration according to the invention makes it possible to treat a volume of effluent at least 2 times greater for an identical water quality at the outlet.

1.-14. (canceled)

15. A method for treating water with the aim of trapping metals and/or metalloids and/or radionuclides and/or biocides contained therein, wherein said method comprises employing a woven or nonwoven composite textile of natural and/or synthetic and/or artificial fibres and lignocellulosic particles entangled between said fibres comprising more than 30% by weight of said lignocellulosic particles,
said nonwoven textile being able to be obtained according to steps (a)-(c):
(a) napping a card web of said fibres with deposition of lignocellulosic particles between each card web layer,
(b) pressing the whole obtained in step (a), and
(c) consolidating the whole obtained in step (b) by needling and/or thermobonding;
said woven textile being able to be obtained by a process wherein the lignocellulosic particles are deposited in the card web which is then spun then woven.

16. The method according to claim 15, wherein the size of the lignocellulosic particles is between 0.4 and 3 mm.

17. The method according to claim 15, wherein the size of the lignocellulosic particles is less than 1 mm.

18. The method according to claim 15, wherein the textile comprises 30% to 80% by weight of particles in relation to the total weight of the textile.

19. The method according to claim 15, wherein the textile comprises 40% to 75% by weight of particles in relation to the total weight of the textile.

20. The method according to claim 15, wherein the textile comprises 20% to 80% by weight of fibres in relation to the total weight of the textile.

21. The method according to claim 15, wherein the textile comprises 30% to 50% by weight of fibres in relation to the total weight of the textile.

22. The method according to claim 15, wherein the textile has a thickness of between 3 mm and 20 mm.

23. The method according to claim 15, wherein the textile has a thickness of between 8 mm and 15 mm.

24. The method according to claim 15, wherein the textile has a weight of between 0.1 kg/m² and 2 kg/m².

25. The method according to claim 15, wherein the textile has a weight of between 0.8 kg/m² and 1.5 kg/m².

26. The method according to claim 15, wherein the fibres consist of plant fibres.

27. The method according to claim 15, characterised in that the textile is biodegradable.

28. The method according to claim 15, wherein the fibres consist of natural and/or artificial fibres.

29. The method according to claim 15, wherein the fibres consist of synthetic fibres.

30. The method according to claim 15, said metals being selected from the group consisting of lead, nickel, chromium, zinc, copper, gold, silver, and iron.

31. The method according to claim 15, said radionuclides being selected from the group consisting of uranium, plutonium, palladium, and americium.
